(19) United States
(12) Patent Application Publication
(10) Pub. No.: US 2005/0235087 A1
(43) Pub. Date: Oct. 20, 2005

(54) Method, article of manufacture and apparatuses for establishing an isochronous signal for transmission to a signal receiving device

(76) Inventor: Christopher J. Stone, Newtown, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/825,644

(22) Filed: Apr. 15, 2004

(51) Int. Cl. G06F 13/00

(52) U.S. Cl. 710/305

(57) ABSTRACT

A method (200) for automatically establishing an isochronous signal for transmission to a signal receiving device includes: using a serial bus (80) responsive to a set-top device (10) and a first signal receiving device (12), the serial bus having an architecture defined by an Institute of Electrical and Electronics Engineers (“IEEE”)-1394 specification, discovering (202) a signal receiving capability of the first signal receiving device (12); and without user intervention, based on the discovered signal receiving capability, producing (204) an isochronous signal (14) for transmission to the first signal receiving device (12) over the serial bus (80).

### FIELD OF THE INVENTION

Aspects of this invention relate generally to digital signal transmission and reception, and, more particularly, to a method, article of manufacture, and apparatuses for automatically establishing an isochronous signal for transmission to a signal receiving device, via a serial bus.

### BACKGROUND OF THE INVENTION

Digital programming from a wide variety of sources may be delivered to, and received by, consumers using a wide variety of devices. Television networks and stations, studios, Internet broadcasters, Internet service providers, cable operators and satellite operators, among others, deliver digital programming to consumers, and consumers may receive and/or create digital programming through the use of devices such as digital televisions (“DTVs”), digital video camera recorders (“camcorders”), video cassette recorders (“VCRs”), hard disk drives, digital video disk (“DVD”) recorders, teleconferencing devices, and video production devices, among other devices. Devices and interfaces involved in the delivery, receipt, and creation of digital programming may comply with various industry specifications, or standards, which have been promulgated by groups desiring, among other things, to ensure interoperability between systems and devices that deliver, receive or create the digital programming.

The Institute for Electrical and Electronics Engineers (“IEEE”), for example, has published, or is in the process of considering for publication, a series of specifications (including but not limited to the IEEE 1394-1995 Serial Bus Specification, the IEEE 1394a Supplement, and the IEEE 1394.B Specification, among others, hereinafter referred to as the “IEEE-1394 Specifications”) that define a serial bus architecture capable of isochronous transmission of digital signals between multiple source and receiving devices connected thereto. The IEEE-Specifications are hereby incorporated by reference in their entirety for all purposes, as if set forth in full herein. Apple Computer, Inc. sells a serial bus known as FireWire™, which is consistent with the IEEE-1394 Specifications. Sony Corporation also sells a serial bus—i.LINK™—that is based on the IEEE-1394 Specifications.

A specific standard relating to implementation of IEEE-1394 interfaces for DTVs has been promulgated by the Electronic Industries Alliance (“EIA”), entitled “EIA-775-A DTV 1394 Interface Specification” (hereinafter referred to as “the EIA-775 Specification”), published in April, 2000, which is hereby incorporated by reference in its entirety for all purposes, as if set forth in full herein. The Society of Cable Telecommunications Engineers (“SCTE”) has also set forth a standard entitled “ANSI/SCTE 26 2001,” which defines how cable set-top devices interconnect with DTVs compatible with the EIA-775 Specification, and which is also hereby incorporated by reference in its entirety for all purposes, as if set forth in full herein.

Consumer devices, such as DTVs, camcorders, VCRs, hard disk drives, DVD recorders, teleconferencing devices, and video production devices, cable or terrestrial set-top devices, and personal computers, among other devices, which may be both signal source and signal receiving devices, may be equipped with IEEE-1394 interfaces, and connected, via the interfaces, to a serial bus based on the IEEE-1394 Specifications.

Despite the advantages of communication between a wide variety of devices over a single bus, setting up signal source and receiving devices that share a serial bus based on the IEEE-1394 Specifications maybe challenging for a consumer. In one common example, a consumer having a cable or terrestrial set-top device in communication with a receiving device, such as a DTV, over a FireWire™ or i.Link™ serial bus, is required to input a variety of information at the set-top device and/or DTV to enable the DTV to receive displayable signals over an isochronous channel from the set-top device via the serial bus. For example, the consumer may be required to use interfaces such as remote controls or keypads to input information to on-screen displays, such as menus, to select the set-top device as a source device, or the DTV as a receiving device. Although some DTVs may be equipped to recognize certain source devices, because receiving devices are not currently required to undergo 1394-compliance testing or certification, there is no guarantee that the designated DTV is able to recognize and/or properly select the source device autonomously.

There are therefore needs for methods, articles of manufacture, and apparatuses for establishing isochronous signals for transmission to signal receiving devices, which utilize features of serial buses based on the IEEE-1394 Specifications, and which do not require extensive set-up processes by consumers.

### SUMMARY OF THE INVENTION

In accordance with an aspect of the present invention, a method for automatically establishing an isochronous signal for transmission to a signal receiving device includes: using a serial bus responsive to a set-top device and a first signal receiving device, the serial bus having an architecture defined by an Institute of Electrical and Electronics Engineers (“IEEE”)-1394 specification, discovering a signal receiving capability of the first signal receiving device; and without user intervention, based on the discovered signal receiving capability, producing an isochronous signal for transmission to the first signal receiving device over the serial bus.

The method may further include transmitting the produced isochronous signal to the first signal receiving device over the serial bus. A second signal receiving device may also be connected to the serial bus, and the signal receiving capability of the second signal receiving device discovered. In certain cases, such as when the set-top device supports a single isochronous point-to-point connection on the serial bus, the isochronous signal may be produced for transmission to either the first or second signal receiving device, depending on which device is closest to the set-top device. The determination of which receiving device is closest may be made by causing a ping packet to be sent to the first signal receiving device and the second signal receiving device, and measuring an amount of time it takes for each of the first and second signal receiving devices to return data based on the ping packet. Based on the measured amount of time, such as the shortest measured time, the isochronous signal may be produced for transmission to the signal receiving device closest to the set-top device.

In some cases, digital content may be transmittable from the set-top device to the first signal receiving device via the serial bus, and analog content may be transmittable from the set-top device to the first signal receiving device via an analog interface. Prior to sending analog content via the analog interface, it may be determined whether the first signal receiving device is responsive to the analog interface, by measuring a resistance associated with the analog interface, or by assuming that the first signal receiving device is not responsive to the analog interface. When the first signal receiving device is not responsive to the analog interface, a message (for example, an on-screen display of a digital television signal, informing a user that an analog connection between the set-top device and the first signal receiving device is desirable) may be produced for transmission to the first signal receiving device over the serial bus.

In accordance with another aspect of the present invention, a computer-readable storage medium is encoded with a computer program which, when loaded into a processor, implements the foregoing method.

In accordance with a further aspect of the present invention, an apparatus for automatically establishing an isochronous signal for transmission to a signal receiving device includes a computer-readable storage medium. A processor is responsive to the computer-readable storage medium and to a computer program, and the computer program, when loaded into the processor, is operative to perform a method including: using a serial bus responsive to a set-top device and the signal receiving device, the serial bus having an architecture defined by an EEEE-1394 specification, discovering a signal receiving capability of the first signal receiving device; and without user intervention, based on the discovered signal receiving capability, producing an isochronous signal for transmission to the signal receiving device over the serial bus.

In accordance with a still further aspect of the present invention, a set-top device for use within a broadband communications system includes an interface to a serial bus. The serial bus is responsive to a signal receiving device and has an architecture defined by IEEE-1394 specification. The set-top device further includes a processor. A computer readable medium is encoded with a computer program which, when loaded into the processor, is operative to perform a method including: discovering a signal receiving capability of the signal receiving device; and without user intervention, based on the discovered signal receiving capability, producing an isochronous signal for transmission to the signal receiving device via the interface to the serial bus.

The set-top device may be a cable or terrestrial set-top device. The isochronous signal may be a displayable digital television signal, such as an on-screen display or a signal for recording by a recording device. The signal receiving device may be a display device, a digital video cassette recorder, a hard disk drive, a digital video camera recorder, or a digital video disk recorder. The broadband communications system may be a cable television system.

### BRIEF DESCRIPTION OF THE DRAWINGS

FIG. 1 is a block diagram of system showing a set-top device and a signal receiving device in communication via a serial bus based on the IEEE-1394 Specifications, in which various aspects of the present invention may be used.

FIG. 2 is a flowchart of a method for establishing an isochronous signal for transmission to the signal receiving device shown in FIG. 1, in accordance with an aspect of the present invention.

FIG. 3 is a block diagram of a system having multiple signal receiving devices in communication with the set-top device shown in FIG. 1, via the serial bus shown in FIG. 1, illustrating certain aspects of the present invention for identifying a particular receiving device closest to the set-top device.

### DETAILED DESCRIPTION

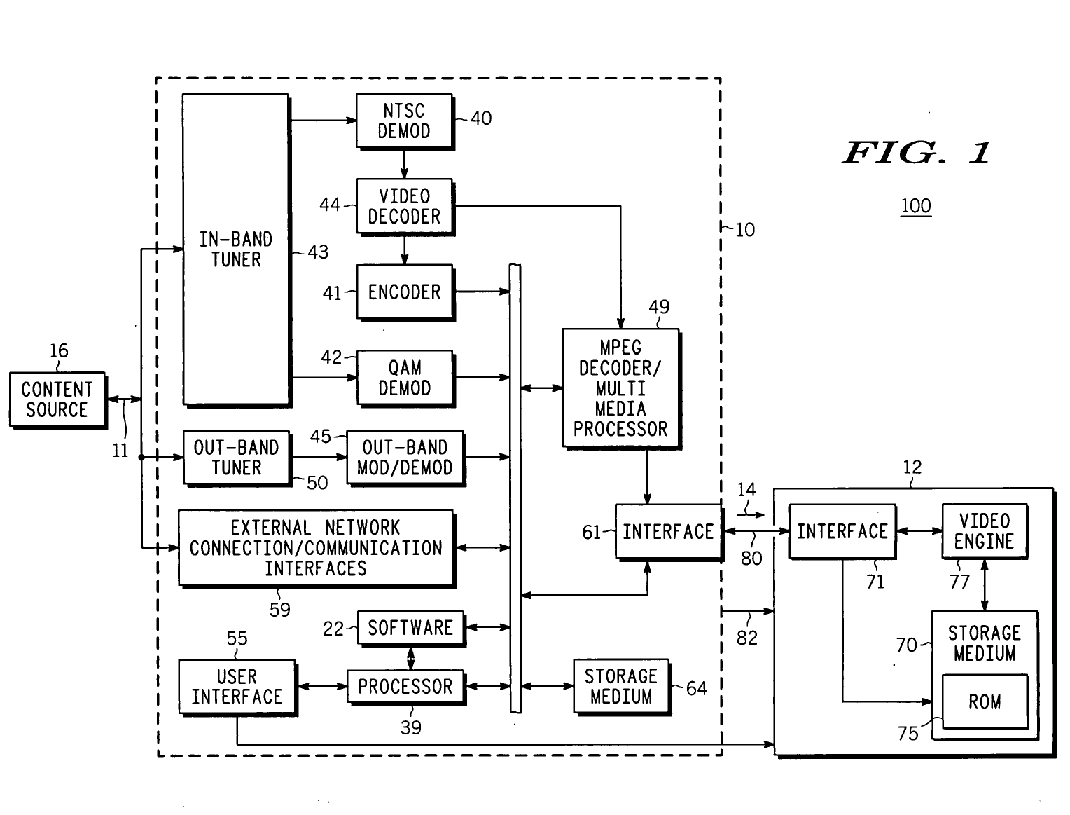

Turning now to the drawings, where like numerals designate like components, FIG. 1 is a block diagram of a system 100 in which various aspects of the invention may be used. A source device 10 serves as a source for delivery of an isochronous signal 14 to a signal receiving device 12, over a serial bus 80. An analog connection and/or interface(s) 82 between source device 10 and receiving device 12 is also provided. Serial bus 80 is based on a series of specifications published or under consideration by the Institute for Electrical and Electronics Engineers (“IEEE”) (including but not limited to the IEEE 1394-1995 Serial Bus Specification, the IEEE 1394a Supplement, and the IEEE 1394.B Specification, among others, hereinafter referred to as the “IEEE-1394 Specifications.)

Source device 10 receives and processes content 11 from content source 16. As shown, source device 10 is a set-top device (for example, Motorola's DCT-6200™ cable set-top box), content source 16 is a hybrid fiber-optic/coax cable network operated by a multi-system operator (“MSO”), content 11 is a digital programming source supplied by the MSO, and signal receiving device 12 is a digital television (“DTV”) monitor.

Source device 10, however, may be any device or combination of devices capable of receiving and/or transmitting content 11 to signal receiving device 12, including but not limited to a terrestrial set-top device, a personal computer, a stereo, a digital video camera recorder (“camcorders”), a video cassette recorder (“VCR”), a hard disk drive, a digital video disk (“DVD”) recorder, a teleconferencing device, a video production device, or any other consumer appliance(s) responsive to an IEEE-1394 interface; content source 16 may be any public or private, wired or wireless, data transmission infrastructure or technology, including but not limited to a fiber-optic network, a coaxial cable network, a hybrid network, a satellite network, a cellular network, the Internet, a television network, a radio network, a copper wire network, an interface to a consumer device, or any other existing or future transmission infrastructure or technology, operated by any type of program provider, such as a television network or station, a studio, an Internet broadcaster or service provider, a cable operator, a satellite operator, or a consumer operating a consumer appliance; content 11 may be any pre-recorded or live analog or digital electronic signal representing an image and/or audio, in any format; and signal receiving device 12 may be any receiving device, including but not limited to a display device, such as a television or computer screen, or another type of device, such as a recording or capture device, for example, a camcorder, a VCR, a hard disk drive, or a DVD recorder, among others.

As shown, set-top device 10 includes external network connection/communication interfaces 59, which support devices such as modems, streaming media players and other network connection devices and/or software, coupled through local or wide area networks (not shown) to program providers and providers of other content.

Set-top device 10 further includes an in-band tuner 43, which tunes to a channel signal selected by a consumer (not shown) via user interface 55. User interface 55 is also used to provide requested inputs, such as set-up information, to set-top device 10 and/or signal receiving device 12. User interface 55 may be any type of known or future device or technology (for example, a remote control, mouse, microphone, keyboard, or display) that allows the consumer to select channels or programs the consumer wishes to receive, or devices the consumer wishes to designate.

NTSC Demodulator 40 and QAM Demodulator 42 are responsive to in-band tuner 43. QAM Demodulator 42 may be any type of digital demodulator device that may include, but is not limited to, an ATSC demodulator device. NTSC Demodulator 40 includes components responsive to receive analog versions of a channel signal. QAM Demodulator 42 includes components responsive to receive digital versions of a channel signal. A component of QAM demodulator 42 receives digital data packets from one or more digital sources, such as a digital television signal, a Moving Pictures Experts' Group (“MPEG”) transport stream, or a media stream from external network connection 59, using well-known methods and techniques. A component of NTSC Demodulator 40 receives an analog version of a channel signal, and decodes signals and markers according to well-known methods and techniques. NTSC Demodulator 40 is operative to output signal 17, which includes video or audio data arranged for formatting in accordance with a predetermined media format.

Video decoder 44 is responsive to NTSC Demodulator 40. Video decoder 44 is operative for receiving a signal and converting it into a digital representation of the received signal, which is output as a digital signal(s), arranged in accordance with a desired format, such as Consultative Committee International Radio (CCIR) 656, which is a video transmission standard well known to those skilled the art. The signal(s) may require format translation or modification for compatibility with capabilities of storage medium 64 (discussed further below), and may be passed to encoder 41 for formatting. Certain signals may be in a format preferred for use by MPEG Decoder/Multi Media Processor 49 (also discussed further below), and may be passed directly to MPEG Decoder/Multi Media Processor 49.

Out-of-band tuner 50 is operative to tune to an out-of-band channel signal, such as a control channel signal. Out-of-band modulator/demodulator 45, which includes well-known components operating in well-known manners, is responsive to out-of-band tuner 43.

Encoder 41 is operative to perform predetermined coding techniques to produce an encoded signal for transmission, or for storage in storage medium 64.

Storage medium 64 is responsive to receive, among other things, an encoded or un-encoded signal for storage, and to receive and store contents of a configuration ROM 75 (discussed further below) from receiving device 12. Storage medium 64 may be any local or remote device, now known or later developed, capable of recording data, including but not limited to a hard disk drive, a VCR tape, all types of compact disks and DVDs, a magnetic tape, a home router, or a server.

MPEG Decoder/Multi-Media Processor 49 is operative to perform predetermined coding techniques to arrange signals into displayable formats compatible with DTV 12. Analog signals are preferably passed to MPEG Decoder/Multi Media Processor 49 via NTSC Demodulator 40, and digital signals are preferably passed to MPEG Decoder/Multi Media Processor 49 via signal(s) originating from QAM Demodulator 42. Video information that is retrieved and played back from storage medium 64 (discussed further below) is also passed to MPEG Decoder/Multi Media Processor 49.

MPEG Decoder/Multi-Media Processor 49 formats received video into its Red-Green-Blue (RGB) components, and transmits displayable signals to DTV 12, via IEEE-1394 interface 61 (discussed further below). Internal arrangements of MPEG Decoder/Multi-Media Processor 49 are well known, and may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

IEEE-1394 interface 61 has a physical and logical architecture as set forth in IEEE-1394 Specifications and/or the standard entitled ANSI/SCTE 26 2001, published by the Society of Cable Telecommunications Engineers, and may be part of, or separate from, set-top device 10. IEEE-1394 interface 61 may also be incorporated into MPEG Decoder/Multi Media Processor 49. In operation, IEEE-1394 interface 61 is responsive, via local bus 60, to access, or be accessed by, functions of set-top 10, such as storage medium 64, processor 39 (discussed further below) and software 22 (also discussed further below), and is responsive to DTV 12 via serial bus 80. Among other things, IEEE-1394 interface participates in discovery of the contents of configuration ROM 75 (discussed further below) from DTV 12 via serial bus 80, and, based on the contents of configuration ROM 75, and participates in the determination of a signal receiving capability of DTV 12. Based on the discovered signal receiving capability, IEEE-1394 interface 61 supports the automatic production and transmission of an isochronous signal, such as a displayable signal, to DTV 12 over serial bus 80.

Processor 39 and software 22 are illustrated functionally, and are responsive to various elements of set-top device 10, including demodulators 40, 42, and 45, external network connection/communication interfaces 59, encoder 41, storage medium 64, MPEG Decoder/Multi-Media Processor 49, and IEEE-1394 interface 61. When loaded into a processor, such as processor 39, software 22 is operative to control aspects of the process of the discovery of configuration ROM 75, and to control the production of isochronous signals for automatic transmission to DTV 12 over serial bus 80, in accordance with certain aspects of the present invention (discussed further below).

During normal operation of set-top device 10, a consumer connects one or more signal receiving devices, such as DTV 12, to serial bus 80. Functional arrangements of certain components of DTV 12 are depicted in FIG. 1—IEEE-1394 interface 71, storage medium 70, and video engine 77—that pertain to the discovery of configuration ROM 75 by set-top device 10 via serial bus 80, and the use of the contents of configuration ROM 75 by other functional elements of set-top device 10, such as storage medium 64, processor 39, software 22, and IEEE-1394 interface 61.

DTV 12, which may also include speakers for outputting audio signals, displays signals received at IEEE-1394 interface 71 from set-top device 10 over an isochronous channel on serial bus 80. IEEE-1394 interface 71 has a physical and logical architecture as set forth in the standard entitled “EIA-775-A DTV 1394 Interface Specification,” published in April, 2000 by the Electronics Industries Alliance. IEEE-1394 interface 71 is responsive to IEEE-1394 interface 61 over serial bus 80, to storage medium 70, and to video engine 77, which represents a processor, computer programs and/or physical components operative to implement the functions of DTV 12 relating to display of signal 14.

Certain discovery information must be implemented by every device supporting the EIA-775 DTV 1394 Interface Specification, including configuration ROM 75, having a structure defined in the IEEE-1394 Specifications and other applicable specifications. Information within configuration ROM 75 may discovered by other devices on serial bus 80, such as set-top device 10, to create a functional audio/video entertainment cluster. Information included within a general-format configuration ROM 75 may include information for: identifying the software driver for DTV 12; identifying diagnostic software; specifying bus-related capabilities of DTV 12; and specifying optional module, node, and unit characteristics and parameters. Configuration ROM 75 may also specify capability information for the benefit of signal source devices such as set-tops. Examples of capability information include, but are not limited to: signal receiving capability, such as isochronous signal receiving capability and constraints thereon; bus-related capability; on-screen display formats supported; analog plug numbers upon which the receiving device accepts analog inputs; vendor identifier information; and other capabilities and parameters, or pointers thereto.

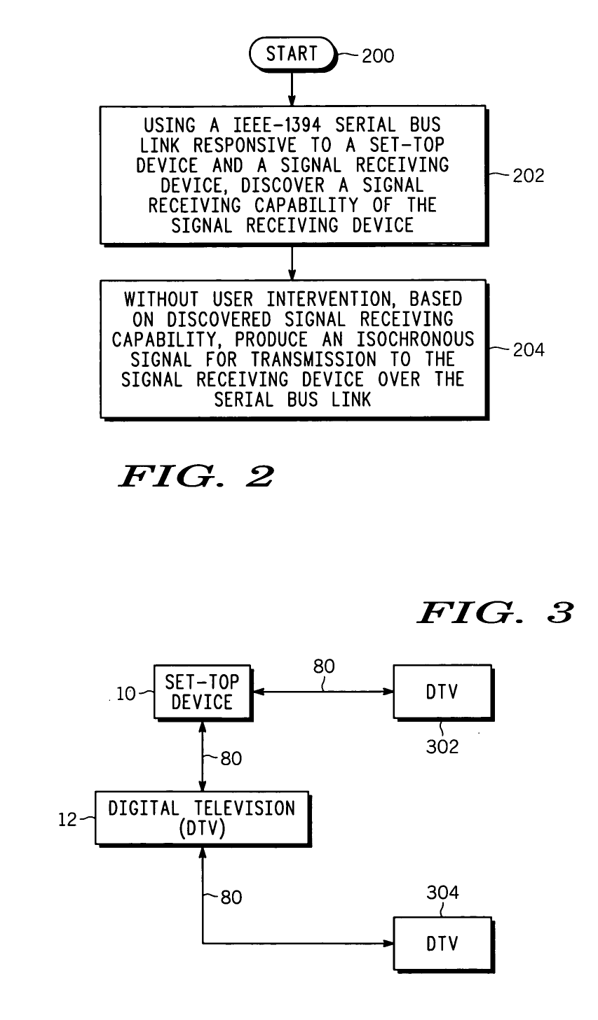

FIG. 2 is a flowchart of a method for establishing an isochronous signal, such as a DTV signal, for transmission to a signal receiving device, such as DTV 12, using a serial bus that has an architecture defined by the IEEE-1394 Specification, such as serial bus 80. The serial bus is responsive to a set-top device, such as set-top device 10, and the signal receiving device.

The method begins at block 200, and continues at block 202, where a signal receiving capability of the signal receiving device is discovered, using the serial bus. The signal receiving capability, among other information, may be included within a data structure associated with the signal receiving device, such as configuration ROM 75, and may be discovered during the configuration process of the serial bus. As set forth in the IEEE-1394 Specifications, the serial bus configuration process occurs in response to a reset of the serial bus—for example, when power is applied to, or removed from, a node, or when a node is attached or detached from the serial bus. During the bus configuration process, each node, including one or more nodes associated with DTV 12, generates and broadcasts, via the serial bus, a self-ID packet that specifies parameters (for example, identification of the node and specification of its serial bus capabilities/characteristics), which may be used by other nodes, such as set-top device 10, that perform certain bus management functions. After the self-ID packets have been broadcast, devices may discover contents of configuration ROMs of other devices on the serial bus using asynchronous read transactions—for example, in reply to an asynchronous transaction initiated by set-top device 10, DTV 12 may supply requested information from configuration ROM 75 to set-top 10. The contents of configuration ROM 75 may be stored in a memory by set-top 10, such as storage medium 64.

At block 204, based on the discovered signal receiving capability, an isochronous signal is produced for transmission to the signal receiving device, without user intervention. When transmission occurs, it is over the serial bus. The initiation of isochronous transactions is one of several bus management functions that may be performed by set-top device 10. Based on the information obtained from DTV 12's self-ID packet during bus configuration, and the discovery of the signal receiving characteristics of DTV 12 from configuration ROM 75, set-top device 10 is able to automatically initiate an isochronous transmission of a signal usable by DTV 12. The isochronous signal may be a signal for immediate display, or one for storage and later display.

For example, after a reset of serial bus 80, set-top device 10 detects the presence of all devices on the bus. The set-top device then reads the Configuration ROM of each device to determine what types of devices are on the serial bus. The set-top then builds a list of devices that are connected to the serial bus and autonomously initiates an isochronous connection transaction to DTVs, which are defined as Monitor types in the Configuration ROM, connected to the serial bus. After each successful connection is made, the set-top device initiates the isochronous channel and transmits digital programming to the DTV(s).

Where set-top device 10 may be limited to a single isochronous point-to-point connection (it should be noted that a point-to-point connection is required for 5C DTCP support and broadcast connections are not allowed, then set-top device 10 selects a single DTV to connect to. Aspects of the present invention utilize the 1394 gap count process (also discussed further below, in connection with FIG. 3) to determines which one of multiple DTVs is actually closest to the set-top device. The gap count utilizes a ping mechanism to determine the actual propagation delay on the 1394 bus. Set-top 10 would utilize the same ping mechanism to build a table that would determine the delay between each device and thus relative distance each device has with respect to the set-top. The logic is that set-top would be placed next to the primary DTV and thus the closest DTV, i.e., the DTV with the smallest delay, would be selected for the isochronous connection. After completion of the ping process, the set-top would determine the closest DTV and autonomously establish the isochronous connection to that DTV.

It is often the case that a signal source device, such as set-top device 10, is limited to passing only digital content to a signal receiving device, such as DTV 12 (for example, in the case where the signal source device is not equipped with an MPEG encoder) via serial bus 80. In that case, analog content is passed over an analog interface, such as analog interface(s) 82, and it may be necessary for the signal source device to tell the signal receiving device when to switch from receiving displayable signals via serial bus 80 to receiving such signals via analog interface 82. Set-top device 10 may, for example, determine of DTV 12 is responsive to analog interface 82. Set-top device 10 may either assume that DTV 12 is not responsive and/or connected to analog interface 82, or may measure a resistance associated with analog interface 82 to determine if DTV 12 is responsive and/or connected to analog interface 82 (for example, set-top device 10 may measure the resistance across the analog output ports (not shown) of set-top device 10). If it is determined that DTV 12 is not responsive and/or connected to analog interface 82, then set-top device 10 may generate an on-screen display for transmission to DTV 12 over serial bus 80. The on-screen display informs a user of DTV 12 that an analog connection between DTV 12 and set-top device 10 is desired or required.

FIG. 3 is a block diagram of an entertainment system 200 having three signal receiving devices (as shown, DTVs 12, 302 and 304) in communication with set-top device 10, via serial bus 80. If set-top device 10 is able to support only a single isochronous point-to-point connection (for example, Digital Transmission Content Protection (DTCP) support requires such a single point-to-point connection—broadcast connections are not allowed), then set-top device 10 may select a single receiving device with which to establish isochronous communication. The receiving device closest to set-top device 10, which is presumably the primary receiving device, may be selected to receive the isochronous transmission. The Gap Count function is one of numerous bus management functions provided for in the IEEE-1394 Specification, and it may be used to gather information about the distance between set-top device 10 and each DTV 12, 302, and 304. Based on knowledge of the topology of serial bus 80 gained during bus configuration, a bus manager, such as set-top device 10, has the ability to broadcast a configuration packet, known as a “ping packet,” to determine gap values for all nodes on serial bus 80. In accordance with the Gap Count function, a ping packet may be sent by set-top device 10 to each DTV 12, 302, and 304 on serial bus 80, and set-top device 10 measures the amount of time it takes for each DTV 12, 302, and 304 to return data, such as a self-ID packet, to set-top 10 in response to the ping packet. Set-top device 10 then builds a table that facilitates determination/comparison of the delays associated with DTVs 12, 302, and 304, and thus the relative distance of each DTV 12, 302 and 304 from set-top device 10. Set-top device 10 may produce an isochronous signal, such as a displayable signal, for transmission to the closest DTV (as shown, DTV 302) over serial bus 80.

The methods illustrated in the flowchart of FIG. 2 may be implemented by any stored instructions, such as software 22. When loaded into a processor, such as processor 39, software 22 would operate to automatically produce an isochronous signal for transmission to a receiving device, over a serial bus having an architecture defined by the IEEE-1394 Specifications. It will be appreciated, however, that aspects of the present invention are not limited to any specific embodiment(s) of computer software or signal processing methods. For example, one or more processors packaged together or with other elements of set-top device 10 may implement functions of processor 39 in a variety of ways. It will also be appreciated~that software 22 may be any stored instructions, including firmware, in one or more parts (stored, for example, on storage medium 64, or another internal or external storage medium such as a read-only-memory or a random-access memory) for implementing functions of set-top device 10, and that software 22 may be used or implemented by one or more elements, including one or more processors, of set-top device 10.

Although a specific architecture has been described herein, including specific functional elements and relationships, it is contemplated that the systems and methods herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method (200) for automatically establishing an isochronous signal for transmission to a signal receiving device, the method comprising:
using a serial bus (80) responsive to a set-top device (10) and a first signal receiving device (12), the serial bus (80) having an architecture defined by an Institute of Electrical and Electronics Engineers (“IEEE”)-1394 specification, discovering (202) a signal receiving capability of the first signal receiving device (12); and
without user intervention, based on the discovered signal receiving capability, producing (204) an isochronous signal (14) for transmission to the first signal receiving device (12) over the serial bus (80).

2. The method according to claim 1, further comprising:
transmitting the produced isochronous signal (14) to the first signal receiving device (12) over the serial bus (80).

3. The method according to claim 1, further comprising:
providing the serial bus (80) between the first signal receiving device (12) and a second signal receiving device (302/304); and
discovering a signal receiving capability of the second signal receiving device (302/304).

4. The method according to claim 3, wherein the step of producing the isochronous signal (14) for transmission comprises producing the isochronous signal (14) for transmission to one of the first (12) and second (302/304) signal receiving devices.

5. The method according to claim 4, wherein the set-top device (10) supports a single isochronous point-to-point connection on the serial bus (80).

6. The method according to claim 4, further comprising:
determining which one of the first signal receiving device (12) and the second signal receiving device (302/304) is closest to the set-top device (10), by causing a ping packet to be sent to the first signal receiving device (12) and the second signal receiving device (302/304), and measuring an amount of time it takes for each of the first and second signal receiving devices to return data based on the ping packet; and
based on the measured amount of time, producing the isochronous signal (14) for transmission to the signal receiving device closest to the set-top device.

7. The method according to claim 1, wherein digital content is transmittable from the set-top device (10) to the first signal receiving device (12) via the serial bus (80), and wherein analog content is transmittable from the set-top device (10) to the first signal receiving device (12) via an analog interface (82).

8. The method according to claim 7, further comprising:
determining if the first signal receiving device (12) is responsive to the analog interface (82).

9. The method according to claim 8, wherein the step of determining comprises measuring a resistance associated with the analog interface (82).

10. The method according to claim 8, wherein the step of determining comprises assuming the first signal receiving device (12) is not responsive to the analog interface (82).

11. The method according to claim 8, further comprising:
when the first signal receiving device (12) is not responsive to the analog interface (82), producing a message for transmission to the first signal receiving device over the serial bus.

12. The method according to claim 11, wherein the message comprises an on-screen display of a digital television signal, informing a user that an analog connection between the set-top device (10) and the first signal receiving device (12) is desirable.

13. A computer-readable storage medium (64) encoded with a computer program (22) which, when loaded into a processor (39), implements the method of claim 1.

14. An apparatus for automatically establishing an isochronous signal (14) for transmission to a signal receiving device (12), the apparatus comprising:
a computer-readable storage medium (64); and
a processor (39) responsive to the computer-readable storage medium (64) and to a computer program (22), the computer program (22), when loaded into the processor (39), operative to perform a method (200) comprising:
using a serial bus responsive to a set-top device and the signal receiving device, the serial bus having an architecture defined by an IEEE-1394 specification, discovering (202) a signal receiving capability of the first signal receiving device; and
without user intervention, based on the discovered signal receiving capability, producing (204) an isochronous signal for transmission to the signal receiving device over the serial bus.

15. A set-top device (10) for use within a broadband communications system, comprising:
an interface (61) to a serial bus (80), the serial bus (80) responsive to a signal receiving device (12) and having an architecture defined by IEEE-1394 specification;
a processor (39);
a computer readable storage medium (64) encoded with a computer program (22) which, when loaded into the processor (39), is operative to perform a method (200) comprising:
discovering (202) a signal receiving capability of the signal receiving device; and
without user intervention, based on the discovered signal receiving capability, producing (204) an isochronous signal for transmission to the signal receiving device via the interface to the serial bus.

16. The set-top device (10) according to claim 15, wherein the set-top device (10) comprises one of a cable set-top device and a terrestrial set-top device.

17. The set-top device (10) according to claim 16, wherein the isochronous signal (14) comprises a displayable digital television signal.

18. The method according to claim 17, wherein the displayable digital television signal comprises one of an on-screen display and a signal for recording by a recording device.

19. The set-top device (10) according to claim 16, wherein the signal receiving device (12) comprises one of a display device; a digital video cassette recorder; a hard disk drive; a digital video camera recorder; and a digital video disk recorder.

20. The set-top device according to claim 19, wherein the broadband communications system comprises a cable television system.
